(19) United States
(12) Patent Application Publication
(10) Pub. No.: US 2025/0375278 A1
(43) Pub. Date: Dec. 11, 2025

(54) DRIVE UNIT FOR ORAL CLEANING, TOOTHBRUSH HANDLE, AND ORAL CLEANING DEVICE

(71) Applicant: Shenzhen Soocas Technology Co., Ltd., Shenzhen (CN)

(72) Inventors: Mengwei ZENG, Shenzhen (CN); Yanqiang LI, Shenzhen (CN); Yi XIE, Shenzhen (CN); Zhoujian LI, Shenzhen (CN)

(73) Assignee: Shenzhen Soocas Technology Co., Ltd., Shenzhen (CN)

(21) Appl. No.: 18/963,774

(22) Filed: Nov. 29, 2024

Related U.S. Application Data
(63) Continuation of application No. PCT/CN2024/124579, filed on Oct. 12, 2024.

(30) Foreign Application Priority Data
Jun. 6, 2024 (CN) 202410733778.7

(51) Int. Cl. A61C 17/38; A46B 13/04

(52) U.S. Cl. CPC A61C 17/38; A46B 13/04; A46B 2200/1066; A61C 2204/002

(57) ABSTRACT

The present application discloses a drive unit for oral cleaning, a toothbrush handle, and an oral cleaning device; the oral cleaning device at least includes a driving body and a motion detection component, wherein the driving body extending along a first axis includes a static assembly and a rotary assembly, the rotary assembly is rotatably mounted on the static assembly, the static assembly at least partially surrounds the rotary assembly, and an accommodating chamber is formed in the static assembly; the motion detection component located in the accommodating chamber includes a motion detection assembly and a motion feedback assembly, the motion feedback assembly is connected with the rotary assembly and rotates with the rotary assembly, the motion detection assembly is directly connected with the static assembly, and the motion detection assembly detects a motion position of the rotary assembly through the motion feedback assembly.

### CROSS-REFERENCE TO RELATED APPLICATION

This application is a continuation of International Application No. PCT/CN2024/124579, filed on Oct. 12, 2024, which claims priority to Chinese Patent Application No.202410733778.7 titled “DRIVING APPARATUS FOR ORAL CLEANING, BRUSH HANDLE ASSEMBLY, AND ORAL CLEANER” filed on Jun. 6, 2024, the entire contents of which are incorporated herein by reference.

### TECHNICAL FIELD

The present application relates to the field of oral cleaning appliance technologies, and in particular, to a drive unit for oral cleaning, a toothbrush handle, and an oral cleaning device.

### BACKGROUND

In the related art, for an electric toothbrush, a driving shaft of a motor component inside the electric toothbrush is connected with a brush head to realize a reciprocating swing of the brush head, thereby improving a cleaning efficiency.

However, the motor component of the electric toothbrush usually moves at several groups of set vibration frequencies and/or vibration amplitudes and cannot provide more desired vibrations. For the motor component, the motion of an output shaft may be controlled by providing a motion detection component, but in the prior art, the motion detection component has a complex mounting structure and insufficient mounting precision, resulting in a poor final control effect on a brush head, which may adversely influence a tooth cleaning effect and oral health to a certain extent.

### SUMMARY

An objective of the present application is to provide a drive unit for oral cleaning, a toothbrush handle and an oral cleaning device, which can improve a control effect on the oral cleaning device and improve use experiences of user.

In order to achieve the above objective, in an aspect, the present application provides a drive unit for oral cleaning, at least including a driving body and a motion detection component, wherein the driving body extending along a first axis includes a static assembly and a rotary assembly, the rotary assembly is rotatably mounted on the static assembly, the static assembly at least partially surrounds the rotary assembly, an accommodating chamber is formed in the static assembly, and at least one end of the rotary assembly extends along the first axis and extends to the outside of the static assembly; the motion detection component at least partially located in the accommodating chamber includes a motion detection assembly and a motion feedback assembly, the motion feedback assembly is connected with the rotary assembly and rotates with the rotary assembly, the motion detection assembly is directly connected with the static assembly, and the motion detection assembly detects a motion position of the rotary assembly through the motion feedback assembly.

Compared with the related art in which the connection of the motion detection assembly and the static assembly through a corresponding supporting seat requires two positioning and assembling processes, the technical solution of the present application has the advantages that the motion detection assembly in the drive unit is directly connected with the static assembly, such that the motion detection assembly can be positioned and assembled only through one positioning and mounting operation, thus simplifying an assembling process, obviously reducing assembling complexity, and solving the problem of a large assembling precision difference caused by multiple times of assembling. When the drive unit is applied to an oral cleaning device, such as an electric toothbrush and an irrigation-brushing all-in-one machine, the modification solution of the present application can greatly improve assembly precision of the motion detection assembly, then guarantee control precision of the drive unit, improve the control effect on the oral cleaning device, solve the problems of harm and discomfort caused by an unstable motion or an error of the oral cleaning device due to a poor control effect, and improve the use experience of the user.

Meanwhile, the motion detection component consisting of the motion detection assembly and the motion feedback assembly is mounted in the accommodating chamber. That is, the motion detection component is arranged in the driving body, such that an outward expansion structure is prevented from being formed outside the driving body, thus reducing an overall size of the drive unit to realize more compact miniaturized design. When the drive unit is applied to the oral cleaning device, such as the electric toothbrush and the irrigation-brushing all-in-one machine, the compact structure of the present application not only can make the oral cleaning device slimmer to optimize an aesthetic degree of the electric toothbrush, but also can reserve a larger water storage space in the oral cleaning device to contain more irrigation-brushing liquid, thereby enhancing integral functionality of a product.

In order to achieve the above objective, in another aspect, the present application further provides a toothbrush handle, at least including a grip housing as well as an energy storage component and the drive unit for oral cleaning as described above mounted in the grip housing; wherein the energy storage component is electrically connected with the drive unit, and a power output shaft of the drive unit extends out of the grip housing.

In order to achieve the above objective, in another aspect, the present application further provides an oral cleaning device, at least including a nursing head and the toothbrush handle as described above, the nursing head being detachably connected to the power output shaft.

In order to achieve the above objective, in another aspect, the present application further provides an oral cleaning device, at least including a nursing head and the toothbrush handle as described above; wherein the nursing head has a fluid passage and an outflow opening communicated with the fluid passage, the power output shaft is connected with the nursing head and drives the nursing head to perform a displacement motion, a fluid outlet of an axial passage is communicated with the fluid passage, and the oral cleaning device outputs water flow through the outflow opening for irrigation.

### BRIEF DESCRIPTION OF THE DRAWINGS

To describe the technical solutions of the embodiments of the present application more clearly, the following briefly describes the accompanying drawings required for describing the embodiments. Apparently, the accompanying drawings in the following description only show some embodiments of the present application, and a person of ordinary skill in the art may still derive other drawings from these accompanying drawings without creative efforts.

FIG. 1 is a schematic isometric diagram of a drive unit according to an embodiment of the present application;

FIG. 2 is a schematic half-section diagram of a drive unit according to an embodiment of the present application;

FIG. 3 is a schematic half-section diagram of an outer housing in an embodiment of the present application;

FIG. 4 is a schematic assembly diagram of a stator element and a motion detection assembly in an embodiment of the present application;

FIG. 5 is a schematic enlarged diagram of a joint of a stator element and a motion detection assembly in an embodiment of the present application;

FIG. 6 is a schematic top diagram of a joint of a stator element and a motion detection assembly in an embodiment of the present application;

FIG. 7 is a schematic partial section diagram of assembly of a joining portion and a motion detection assembly in an embodiment of the present application;

FIG. 8 is a schematic exploded diagram of a mounting base and a position feedback part in an embodiment of the present application;

FIG. 9 is a schematic top diagram of a mounting base and a position feedback part in an embodiment of the present application;

FIG. 10 is a schematic top diagram of a mounting base and a position feedback part in another optional embodiment of the present application;

FIG. 11 is a schematic top diagram of a mounting base and a position feedback part in another optional embodiment of the present application;

FIG. 12 is a schematic top diagram of a mounting base and a position feedback part in another optional embodiment of the present application;

FIG. 13 is a schematic cross-sectional diagram of a drive unit according to an embodiment of the present application;

FIG. 14 is a schematic diagram of a toothbrush handle according to an embodiment of the present application; and

FIG. 15 is a schematic diagram of an oral cleaning device according to an embodiment of the present application.

Reference numerals:

110. first axis; 120. accommodating chamber;

200. static assembly; 210. shell element; 211. shell body; 2111. anti-rotation protrusion; 2112. end cover; 2113. cylindrical portion; 212. rear cover; 213. opening; 220. stator element; 221. stator bracket; 222. surface covering element; 2221. joining portion; 22211. support surface; 22212. positioning connecting piece; 22213. elastic buckle; 223. anti-rotation groove;

300. rotary assembly; 310. power output shaft; 311. axial passage; 320. rotor element;

400. motion detection assembly; 410. positioning hole; 420. avoiding space; 430. via hole; 440. wire harness;

500. motion feedback assembly; 510. mounting base; 511. connecting hole; 512. mounting groove; 513. limiting block; 520. position feedback part; 521. limiting groove;

600. tensioning part;

710. grip housing; 720. energy storage component; 730. liquid storage chamber; 740. fluid pumping unit; 750. nursing head; 751. fluid passage; 752. outflow opening.

### DETAILED DESCRIPTION

With the improvement of the living standard of people, oral cavities begin to be cleaned by means of various oral cleaning devices in more and more families, and tools, such as electric toothbrushes, oral irrigators and irrigation-brushing all-in-one machines, are configured to assist in cleaning to improve an oral environment. Taking the electric toothbrush as an example, in the related art, a driving shaft of a motor component inside the electric toothbrush is connected with a brush head to realize a reciprocating swing of the brush head, so as to improve a tooth cleaning efficiency.

However, in most of the electric toothbrushes in the related art, the swing is realized through a common motor, and the common motor usually moves at several groups of set swing frequencies/amplitudes and cannot provide more desired vibrations. Compared with the common motor, a motor with an added Hall sensor has the advantages of being capable of realizing high-precision and high-repeatability position, speed and moment control, having a fast dynamic response and tracking performance, being capable of achieving a set speed in a short time and accurately tracking an instruction, and being capable of realizing smooth speed regulation in a wide rotating speed range. Therefore, in the present application, the motor with the added Hall sensor is used as a power part of the oral cleaning device to improve use experiences of a user.

However, the motor with the added Hall sensor requires precise control instructions and feedback signals to achieve the above effects. A motion detection component of the existing motor has a complex mounting structure and insufficient mounting precision, and the provided or fed-back instruction and feedback signal are not precise enough, such that the control effect on the motor is poor, and then, the control effect on a cleaning motion of the electric toothbrush driven by the motor is poor.

Specifically, when the mounting structure of the motion detection component of the existing motor provided with the Hall sensor is studied in depth, the inventor notices that a circuit board is required to be fixed onto a motor shell through a special bracket. This design requires two precise assembly operations between the motor shell and the circuit board to ensure precision of the circuit board of the Hall sensor. However, due to a size tolerance of each component during machining, the dual-assembly mode further increases an overall assembly error of a system, which in turn affects the control effect on the cleaning motion of the electric toothbrush. Meanwhile, a fixing mode of a magnetic ring is also deliberated. In the prior art, the magnetic ring is usually fixed on a mounting base thereof by an adhesive, but the adhesive may age to cause the magnetic ring to displace and even fall off with prolonging of a using time, thus affecting the control effect on the cleaning motion of the electric toothbrush. Furthermore, the inventor also observes that an additional mounting bracket is arranged in the related art to externally fix the circuit board of the Hall sensor on the motor shell, which seriously increases a volume of the whole motor component, and then increases a volume of the electric toothbrush with the motor component, thus not only affecting attractiveness of the electric toothbrush, but also possibly adversely affecting portability thereof.

Based on this, a mounting position and a mounting mode of the circuit board of the Hall sensor and the magnetic ring are redesigned in the present application. Specifically, in the design, the circuit board of the Hall sensor is directly connected with a static part of a motor assembly, the structure simplifies an assembly process, mounting can be completed only by one operation, assembly complexity is obviously reduced, and assembly precision is improved. The modification guarantees a precise arrangement of the circuit board of the Hall sensor and is beneficial to improving the motion control effect. Meanwhile, in the design, a limiting structure is added between the magnetic ring and the corresponding mounting base, such that displacement of the magnetic ring relative to the mounting base is effectively prevented, and precision of a relative position between the magnetic ring and the Hall sensor is guaranteed, thereby further ensuring the control effect on the cleaning motion of the electric toothbrush. Furthermore, the circuit board of the Hall sensor and the magnetic ring are arranged in the motor assembly, such that expansion of an external structure is avoided, thus reducing an overall size of the motor to realize more compact miniaturized design. The compact structure not only can make the electric toothbrush slimmer to optimize an aesthetic degree of the electric toothbrush, but also can reserve a larger water storage space in the electric toothbrush to contain more irrigation-brushing liquid, thereby enhancing integral functionality of a product.

Furthermore, some people desire to use the oral irrigator or floss in conjunction with the toothbrush to address inconvenience caused by separate use of the oral irrigator and the electric toothbrush during caring for the oral cavity.

Based on this, in the present application, design of the motor assembly is further improved, and specifically, a power output shaft of the motor assembly is designed into a hollow structure, such that the power output shaft can transmit power and be used as a flow passage of liquid to convey the liquid to the brush head, thereby realizing mechanical transmission of the apparatus with an irrigation function and a tooth brushing function.

The technical solutions in the embodiments of the present application are clearly and completely described below with reference to the accompanying drawings. Apparently, the described embodiments of the present application are not all but a part of the embodiments of the present application. All other embodiments obtained by those skilled in the art based on the embodiments of the present application without creative efforts shall fall within the protection scope of the present application.

The present application provides a drive unit which can be used in oral cleaning device; for example, the drive unit can be used as an actuator and applied to an electric toothbrush or an irrigation-brushing all-in-one machine, so as to drive a brush head of the electric toothbrush or the irrigation-brushing all-in-one machine to vibrate at a high frequency and/or swing back and forth, thereby improving a cleaning efficiency. Certainly, the drive unit may also be applied to other cleaning devices requiring high frequency vibrations and/or reciprocating swings, which is not specifically limited in the present application.

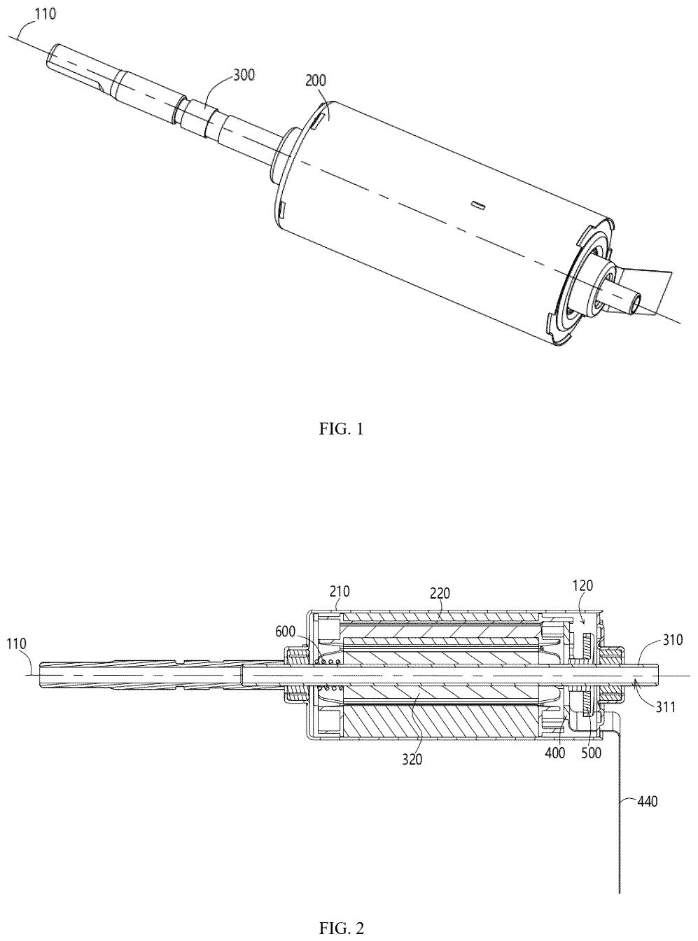

Specifically, referring to FIGS. 1 and 2 together, in an implementable embodiment, the drive unit may at least include a driving body. The driving body is configured to convert electric energy into mechanical energy to output the high-frequency vibrations and/or reciprocating swings. The driving body may include a static assembly 200 and a rotary assembly 300, the rotary assembly 300 is rotatably mounted in the static assembly 200, and at least one end of the rotary assembly 300 extends along a first axis 110 and extends to the outside of the static assembly 200 to be connected with other accessories. During operation of the driving body, the static assembly 200 remains relatively stationary, and the rotary assembly 300 rotates relative to the static assembly 200 to drive a corresponding accessory to move. The static assembly 200 at least partially surrounds the rotary assembly 300, and an accommodating chamber 120 is formed in the static assembly 200. In practical applications, the driving body may be configured in a cylindrical shape, and the first axis 110 is a center line of the driving body; that is, center points of cross sections of the driving body may be located on the first axis 110, and the driving body extends along the first axis 110.

In the present embodiment, the drive unit further includes a motion detection component at least partially located in the accommodating chamber 120, and the motion detection component can be configured to detect a rotation speed of the rotary assembly 300 relative to the static assembly 200, and/or detect a rotation position of the rotary assembly 300 to perform a reversing operation, so as to control the rotary assembly 300 to reversely rotate at a preset position. The motion detection component includes a motion detection assembly 400 and a motion feedback assembly 500. The motion feedback assembly 500 is connected with the rotary assembly 300 and rotates with the rotary assembly 300. The motion detection assembly 400 is directly connected with the static assembly 200, such that the motion detection assembly 400 can determine a position of the rotary assembly 300 by detecting a position of the motion feedback assembly 500 to achieve the above-described detection function. In practical applications, the motion detection assembly 400 may include a circuit board and a position sensor integrated on the circuit board, and the position sensor may be a laser sensor or a Hall sensor, which is not specifically limited in the present application. The motion detection assembly 400 may be connected to a control assembly outside the accommodating chamber 120 by a wire harness 440, such as a wire, a FPC connecting wire, or the like.

It should be noted that, compared with the related art in which the connection of the motion detection assembly 400 and the static assembly 200 through a corresponding supporting seat requires two positioning and assembling processes, the present application has the advantages that the motion detection assembly 400 in the drive unit is directly connected with the static assembly 200, such that the motion detection assembly 400 can be positioned and assembled only through one positioning and mounting operation, thus simplifying an assembling process, obviously reducing assembling complexity, and solving the problem of a large assembling precision difference caused by multiple times of assembling. When the drive unit is applied to an oral cleaning device, such as an electric toothbrush and an irrigation-brushing all-in-one machine, the modification solution of the present application can greatly improve consistency of assembly precision of the motion detection assembly 400, then assist in improving a control effect on a cleaning motion of the electric toothbrush, and improve use experiences of a user.

Meanwhile, the motion detection component consisting of the motion detection assembly 400 and the motion feedback assembly 500 is mounted in the accommodating chamber 120. That is, the motion detection component is arranged in the driving body, such that an outward expansion structure is prevented from being formed outside the driving body, thus reducing an overall size of the drive unit to realize more compact miniaturized design. When the drive unit is applied to the oral cleaning device, such as the electric toothbrush and the irrigation-brushing all-in-one machine, the compact structure of the present application not only can make the oral cleaning device slimmer to optimize an aesthetic degree of the electric toothbrush, but also can reserve a larger water storage space in the oral cleaning device to contain more irrigation-brushing liquid, thereby enhancing integral functionality of a product.

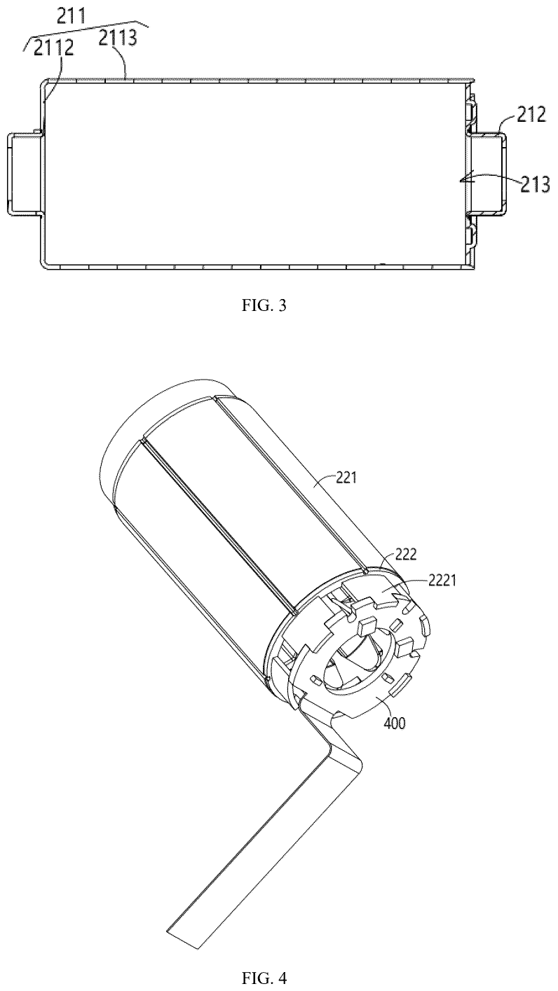

Referring to FIGS. 2 and 3 together, in an implementable embodiment, the static assembly 200 may include a shell element 210 and a stator element 220 accommodated within the shell element 210. The stator element 220 is fixedly connected with the shell element 210, such that the stator element 220 remains stationary with the shell element 210 during operation of the drive unit. A predetermined distance is reserved between the stator element 220 and an end portion of at least one end (the left end and/or right end as shown in FIGS. 2 and 3) of the shell element 210 in an extending direction of the first axis 110, such that the motion detection component is located at one end of the stator element 220 along the first axis 110.

The shell element 210 may be of one-piece design; for example, the shell element 210 may be formed integrally by bending.

The shell element 210 may also be of split design; for example, the shell element 210 includes a shell body 211 and a rear cover 212. The shell body 211 is configured in a cylindrical structure, an axis of the shell body 211 is collinear with the first axis 110, and an opening 213 is formed in one end of the shell body 211, such that the stator element 220, the rotary assembly 300, and the motion detection component can be conveniently mounted into the shell body 211 through the opening 213. The rear cover 212 is connected with the shell body 211 and at least partially covers the opening 213, and when the stator element 220, the rotary assembly 300 and the motion detection component are mounted into the shell body 211 through the opening 213, the rear cover 212 can at least partially cover the opening 213 to avoid that foreign objects enter the shell body 211 to affect normal operation of the drive unit.

When the shell element 210 is of the split design formed by connecting the shell body 211 and the rear cover 212 with each other, in an implementable embodiment, the motion detection component may be located at an end of the stator element 220 close to the rear cover 212 (as shown in FIG. 2). In another optional embodiment, the motion detection component may also be located at an end of the stator element 220 away from the rear cover 212, which is not specifically limited in the present application.

The present application provides various implementable embodiments of a specific connection manner in which the motion detection assembly 400 can be positioned and assembled by one positioning and mounting operation, and reference may be made to the following content for details.

In an implementable embodiment, the motion detection assembly 400 is directly connected with the shell body 211. Specifically, as shown in FIG. 3, the shell body 211 includes an end cover 2112 and a cylindrical portion 2113 which are integrally formed, and the motion detection assembly 400 is directly connected with an inner circumferential wall of the cylindrical portion 2113. The shell body 211 may also be directly connected with an inner side of the end cover 2112 when the motion detection component is located at the end of the stator element 220 away from the rear cover 212.

In another optional embodiment, the stator element 220 may include a stator bracket 221. The stator bracket 221 is configured to provide stable support for a stator within the drive unit, so as to maintain the stator at a correct position in the drive unit. The motion detection assembly 400 is directly connected with the stator bracket 221.

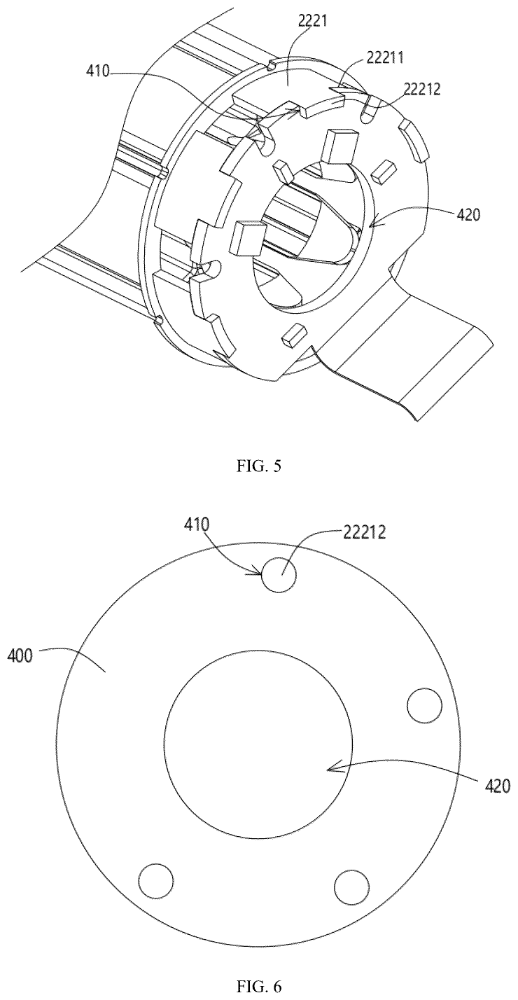

In another optional embodiment, as shown in FIG. 4, the stator element 220 may include a stator bracket 221 and a surface covering element 222, and the surface covering element 222 at least partially covers the stator bracket 221 to form an insulating layer to prevent a current leakage and an accidental short circuit. The motion detection assembly 400 is directly connected with the surface covering element 222.

It should be noted that the surface covering element 222 is integrated with the stator bracket 221 by injection molding; that is, the surface covering element 222 is formed by injection molding, and manufacturing precision thereof can be higher, such that assembly precision of the motion detection assembly 400 and the surface covering element 222 can be further improved, and then, a control performance of the drive unit is improved, thereby further guaranteeing consistency of the swing of the brush head. The surface covering element 222 may be made of plastic, rubber or thermoplastic elastomer. Therefore, the direct connection of the motion detection assembly 400 and the surface covering element 222 is preferably adopted in the present application, and the following description is also given based on this.

The motion detection assembly 400 may be connected with an inner circumferential wall, an outer circumferential wall, or an end portion of the surface covering element 222. For convenience of understanding of a specific connection structure of the motion detection assembly 400 and the surface covering element 222, referring to FIG. 4, taking the case where the motion detection assembly 400 is connected with the end portion of the surface covering element 222 as an example, in an implementable embodiment, the surface covering element 222 extends along the first axis 110, and one end of the surface covering element 222 extends to the outside of the stator bracket 221 to form a joining portion 2221, such that the surface covering element 222 is connected with the motion detection assembly 400 through the joining portion 2221.

In an implementable embodiment, the joining portion 2221 may be connected with the motion detection assembly 400 by means of plastic deformation. Specifically, as shown in FIG. 5, a support surface 22211 and a positioning connecting piece 22212 extending from the support surface 22211 in a direction away from the stator bracket 221 are formed at an end of the joining portion 2221 away from the stator bracket 221. The support surface 22211 is configured to support the motion detection assembly 400, and the support surface 22211 is substantially perpendicular to the first axis 110, such that the support surface 22211 can be parallel to the motion detection assembly 400 to increase a contact area between the support surface 22211 and the motion detection assembly 400 to improve support stability. The positioning connecting piece 22212 is configured to position and connect the motion detection assembly 400.

A positioning hole 410 matched with the positioning connecting piece 22212 is formed in the motion detection assembly 400, and an inner contour of the positioning hole 410 is fitted with an outer contour of the positioning connecting piece 22212 to position the motion detection assembly 400. An extension length of the positioning connecting piece 22212 is greater than a hole depth of the positioning hole 410. When the motion detection assembly 400 is positioned and mounted on the joining portion 2221 in the extending direction of the first axis 110 by fitting the positioning connecting piece 22212 with the positioning hole 410, the motion detection assembly 400 abuts against the support surface 22211, the positioning connecting piece 22212 passes through the positioning hole 410, a part of the positioning connecting piece 22212 passing through the positioning hole 410 forms a blocking structure by plastic deformation, the blocking structure extends in a direction perpendicular to the first axis 110 and abuts against a side of the motion detection assembly 400 away from the support surface 22211, and the blocking structure cooperates with the support surface 22211 to block the motion detection assembly 400 from moving in the extending direction (the left and right direction in FIG. 2) of the first axis 110.

The plastic deformation refers to a permanent shape change of a material under the action of an external force. When the external force is removed, the material cannot be restored to an original shape or size. In an implementable embodiment, the part of the positioning connecting piece 22212 passing through the positioning hole 410 is heated, deformed and solidified to realize the plastic deformation. In practical applications, the part of the positioning connecting piece 22212 passing through the positioning hole 410 is bent by heating, and then plastically deformed by solidification. Certainly, the part of the positioning connecting piece 22212 passing through the positioning hole 410 realizes hot melting deformation by heating to form a glob shape, and is then plastically deformed by solidification. In another optional embodiment, the part of the positioning connecting piece 22212 passing through the positioning hole 410 may also directly realize plastic deformation by a force, i.e., a permanent shape change which occurs when the part of the positioning connecting piece 22212 passing through the positioning hole 410 is subjected to stress exceeding an elastic limit thereof.

Referring again to FIG. 5, in an implementable embodiment, a number of the joining portions 2221 is at least two, and the at least two joining portions 2221 are spaced apart around a circumference of the stator bracket 221, such that the stator bracket can be connected with the motion detection assembly 400 through the plural joining portions 2221, so as to improve stability of the connection of the motion detection assembly 400 and avoid connection failure of the motion detection assembly 400 in a high-frequency vibration environment of the drive unit. Meanwhile, the at least two joining portions 2221 are spaced apart, and a heat dissipation passage may be further formed between every two adjacent joining portions 2221, such that heat in the static assembly 200 and the rotary assembly 300 can be transferred out through the heat dissipation passage to improve a heat dissipation effect.

In another optional embodiment, the plurality of joining portions 2221 may be adjacent in sequence to form a continuous integral structure, for example, a continuous ring structure (O shape) or an open ring structure (C shape). Certainly, some of the plural joining portions 2221 may form a continuous integral structure, and other joining portions 2221 may be spaced apart, which is not specifically limited in the present application.

The support surface 22211 is formed at the end of each joining portion 2221 away from the stator bracket 221, and the positioning connecting pieces 22212 are provided on at least some of the joining portions 2221. That is, each of the joining portions 2221 may have the support surface 22211 and the positioning connecting piece 22212 formed thereon; or, each of the joining portions 2221 may have the support surface 22211 formed thereon, but only some of the joining portions 2221 may have the positioning connecting pieces 22212 formed thereon. In practical applications, a number of the positioning connecting pieces 22212 may be one, two, three, four, five, or the like, which is not specifically limited in the present application.

Preferably, there should be at least three positioning connection pieces 22212, and the at least three positioning connection pieces 22212 are not collinear. Thus, when the motion detection assembly 400 is positioned and connected onto the joining portion 2221 through the at least three positioning connecting pieces 22212, the at least three positioning connecting pieces 22212 can provide a stable support structure for the motion detection assembly 400, such that the motion detection assembly 400 can be maintained at a predetermined position to prevent the motion detection assembly 400 from moving or rotating in a space. Meanwhile, the at least three positioning connecting pieces 22212 may help to distribute a load more evenly, thus reducing wobbling or shifting of the motion detection assembly 400 due to stress concentration or deformation of some of the positioning connecting pieces 22212 caused by load concentration.

In an implementable embodiment, when viewed in a section of a straight line perpendicular to the first axis 110, i.e., a cross section, before the positioning connecting piece 22212 is plastically deformed, the positioning hole 410 and the positioning connecting piece 22212 have the same sectional shape which is at least one of a circular shape, a rectangular shape, a sector shape, and an oval shape. Certainly, the sectional shape of the positioning hole 410 may be other special shapes, which is not specifically limited in the present application. In practical applications, the sectional shapes of the plural positioning holes 410 may be the same or different; for example, when there are four positioning holes 410, the sectional shapes of the four positioning holes 410 may be all sector shapes. Certainly, one positioning hole 410 may be circular and three positioning holes 410 may have sector shapes.

As shown in FIGS. 5 and 6, in an implementable embodiment, the plurality of positioning holes 410 may be provided adjacent to an outer circumferential wall of the motion detection assembly 400, such that more positioning holes 410 may be arranged using a peripheral region of the motion detection assembly 400 having a larger area, so as to increase connection points of the motion detection assembly 400 and the joining portion 2221, provide better structural stability and then more uniformly distribute the load acting an object to reduce stress concentration.

Further, as shown in FIG. 5, the positioning hole 410 is communicated with the outer circumferential wall of the motion detection assembly 400, such that the motion detection assembly 400 can be mounted by clearly referring to an edge, thus simplifying a mounting process. When the positioning connecting piece 22212 is in positioning fit with the positioning hole 410, the positioning connecting piece 22212 is substantially flush with the outer circumferential wall of the motion detection assembly 400. In this way, on the one hand, an aesthetic degree of the connection between the motion detection assembly 400 and the joining portion 2221 can be ensured; on the other hand, projection of the motion detection assembly 400 on the stator element 220 along the first axis 110 may be located within a range of the stator element 220; that is, it is avoided that the motion detection assembly 400 protrudes outwards in a radial direction of the stator element 220 to increase an overall volume of the drive unit, which is beneficial to the miniaturized design of the drive unit. In another optional embodiment, as shown in FIG. 6, the positioning hole 410 is not communicated with the outer circumferential wall of the motion detection assembly 400; that is, a certain distance is reserved between the positioning hole 410 and the outer circumferential wall of the motion detection assembly 400.

The rotary assembly 300 is required to extend out of the stator element 220 and be rotatably connected with both ends of the shell element 210. Therefore, the motion detection assembly 400 is also required to be provided with an avoiding space 420 defined by an inner circumferential wall of the motion detection assembly 400. When the motion detection assembly 400 is connected with the joining portion 2221 of the surface covering element 222, an axis of the avoiding space 420 is substantially collinear with an axis of the rotary assembly 300, such that the rotary assembly 300 can at least partially extend out of the stator element 220 through the avoiding space 420.

In practical applications, the motion detection assembly 400 may include a circuit board and a position sensor integrated on the circuit board, and the position sensor may be a laser sensor or a Hall sensor, which is not specifically limited in the present application. The positioning hole 410 is formed in the circuit board, and the circuit board may be configured into a continuous ring structure or an open ring structure, such that an inner circumferential wall of the circuit board defines the avoiding space 420.

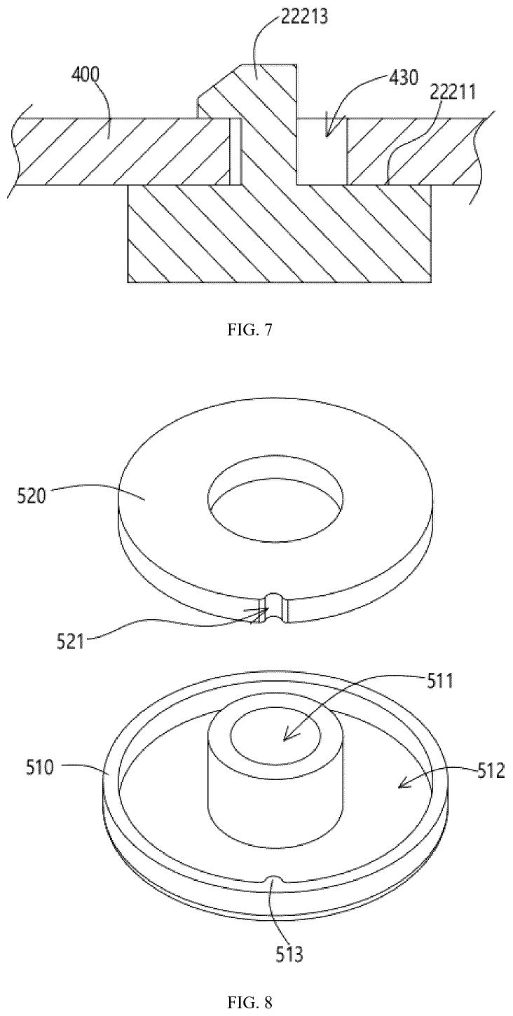

In another optional embodiment, the joining portion 2221 may be connected with the motion detection assembly 400 by means of elastic deformation. Specifically, as shown in FIG. 7, an elastic buckle 22213 and a support surface 22211 for supporting the motion detection assembly 400 are formed at the end of the joining portion 2221 away from the stator bracket 221. Correspondingly, a via hole 430 is formed in the motion detection assembly 400, and when the motion detection assembly 400 is connected with the joining portion 2221 along the extending direction of the first axis 110, the motion detection assembly 400 presses the elastic buckle 22213, such that the elastic buckle 22213 elastically deforms to pass through the via hole 430; after the elastic buckle 22213 passes through the via hole 430, the elastic buckle 22213 is restored to an initial state to be buckled to a side of the motion detection assembly 400 away from the support surface 22211, and the motion detection assembly 400 abuts against the support surface 22211, such that the motion detection assembly 400 is blocked from moving along the extending direction of the first axis 110 under the combined action of the elastic buckle 22213 and the support surface 22211.

Further, the elastic buckle 22213 may also be used in cooperation with a positioning pin; for example, the elastic buckle 22213 and the positioning pin are simultaneously formed at the end of the joining portion 2221 away from the stator bracket 221, and correspondingly, the via hole 430 and the positioning hole 410 matched with the positioning pin are simultaneously formed in the motion detection assembly 400. In this way, the motion detection assembly 400 can be positioned and fitted on the joining portion 2221 by fitting the positioning pin with the positioning hole 410, and snapped by the elastic buckle 22213 to realize precise fixing.

Referring again to FIG. 2, in an implementable embodiment, the rotary assembly 300 may include a power output shaft 310 and a rotor element 320. The power output shaft 310 is rotatably mounted to the static assembly 200, the rotor element 320 is fixedly connected with the power output shaft 310, and when the rotor element 320 rotates in response to an interaction between a current and a magnetic field, the rotor element 320 drives the power output shaft 310 to rotate. The motion feedback assembly 500 is fixedly connected with the power output shaft 310, such that the motion feedback assembly 500 rotates with the rotation of the power output shaft 310, and therefore, the motion detection assembly 400 determines a motion position of the rotor element 320 by detecting a motion position of the motion feedback assembly 500.

The rotor element 320, the motion feedback assembly 500 and the motion detection assembly 400 are arranged at intervals along the extending direction of the first axis 110, the motion feedback assembly 500 may be located between the rotor element 320 and the motion detection assembly 400, and the motion feedback assembly 500 may also be located on a side of the motion detection assembly 400 away from the rotor element 320, which is not specifically limited in the present application.

Referring to FIGS. 2 and 8 together, in an implementable embodiment, the motion feedback assembly 500 includes a mounting base 510 and a position feedback part 520. A connecting hole 511 is formed in the mounting base 510, and the mounting base 510 fixedly sleeves the power output shaft 310 through the connecting hole 511 to rotate with the power output shaft 310. A mounting groove 512 is further formed in the mounting base 510, the mounting groove 512 is formed on a periphery of the connecting hole 511, and the position feedback part 520 is mounted in the mounting groove 512, such that the position feedback part 520 can rotate with the power output shaft 310 through the mounting base 510. A groove opening of the mounting groove 512 is provided towards the motion detection assembly 400, and the motion detection assembly 400 is configured to detect a motion position of the position feedback part 520.

It should be noted that the position feedback part 520 is mounted on the power output shaft 310 through the mounting base 510, such that mounting stability of the position feedback part 520 can be improved, and a pressing force on the position feedback part 520 during the mounting process can be reduced, so as to prevent the position feedback part 520 from being damaged or unstable during a motion process. Since the mounting stability and structural stability of the position feedback part 520 are improved, reliability of the result of detection of the position of the position feedback part 520 by the motion detection assembly 400 can be improved, thereby improving a control effect on a swing process of the brush head.

In practical applications, the mounting base 510 may be a plastic part or a metal part, such as a copper part, so as to improve structural strength of the mounting base 510 and connection stability between the mounting base 510 and the power output shaft 310. The mounting base 510 and the power output shaft 310 may be connected with each other by a key connection, adhesion, welding, heat shrink, or cold shrink, which is not specifically limited in the present application.

In an implementable embodiment, the Hall sensor is integrated on the circuit board of the motion detection assembly 400, and correspondingly, the position feedback part 520 is a magnetic part, and the motion detection assembly 400 detects the motion position of the position feedback part 520 by magnetic induction to determine the motion position of the rotor element 320, thereby improving the reliability of the detection result.

In practical applications, the position feedback part 520 has at least two opposite magnetic poles. Correspondingly, two Hall sensors are integrated on the circuit board of the motion detection assembly 400, and the two Hall sensors are spaced apart along a circumference of the first axis 110 and configured to sense the two opposite magnetic poles of the position feedback part 520. The position feedback part 520 may be formed by connecting two magnets with different magnetic poles, or the two different magnetic poles may be formed by magnetizing different regions of the same magnet, which is not limited herein as long as the magnetic part has two opposite magnetic poles. The two Hall sensors are mounted corresponding to two preset positions of the position feedback part 520 respectively, and the position feedback part 520 can be detected by the corresponding Hall sensor at any preset position, such that the circuit board can control the power output shaft 310 to rotate back and forth between the two preset positions of the position feedback part 520.

In an implementable embodiment, the spacing between the motion detection assembly 400 and the position feedback part 520 ranges from 1 mm to 3 mm. In this way, the position feedback part 520 can be detected by the Hall sensor on the motion detection assembly 400, and the motion detection assembly 400 is not interfered by the magnetic field of the position feedback part 520, so as to provide a clear output signal to ensure the control effect of the drive unit.

In an implementable embodiment, the mounting groove 512 extends around an axis of the connecting hole 511 to form a continuous ring shape, and the position feedback part 520 is configured in a ring structure to be fittingly mounted in the mounting groove 512. In practical applications, the position feedback part 520 may be connected with the mounting base 510 by adhesion, such that the above-mentioned structural design may increase a combination area of the position feedback part 520 and the mounting base 510, thus improving the mounting stability.

The motion feedback assembly 500 is required to reciprocate synchronously with the power output shaft 310, that is, to be subjected to a high frequency vibration under normal working conditions, and therefore, a connection interface between the position feedback part 520 and the mounting base 510 is susceptible to fatigue damage. Such damage may cause relative displacement or decoupling of the position feedback part 520 relative to the mounting base 510, thereby affecting precision and reliability of system control.

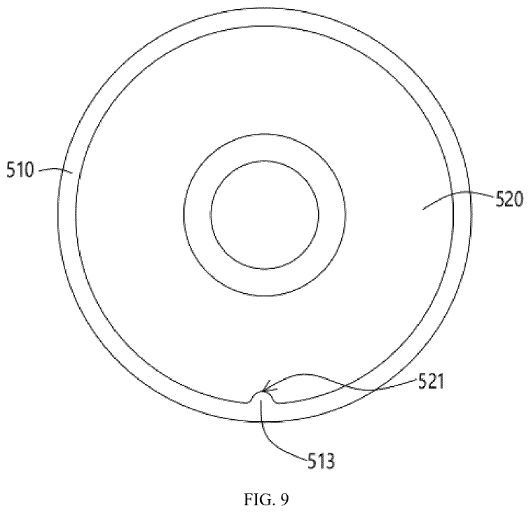

In order to solve the above problem, referring again to FIGS. 8 and 9, in an implementable embodiment, an outer circumferential wall of the mounting groove 512 may be provided with a limiting block 513 extending inwards in a radial direction, and a limiting groove 521 matched with the limiting block 513 is formed in an outer circumferential wall of the position feedback part 520. Thus, when the motion feedback assembly 500 is required to reciprocate synchronously with the power output shaft 310, part of stress can be counteracted by fitting the limiting block 513 with the limiting groove 521, so as to reduce the stress of the connection interface between the position feedback part 520 and the mounting base 510 and reduce possibility of the fatigue damage to the connection interface between the position feedback part 520 and the mounting base 510. Meanwhile, in the process of mounting the position feedback part 520 in the mounting groove 512, the position feedback part can be mounted by referring to the limiting block 513, so as to avoid that the precision of the system control is influenced by mounting dislocation.

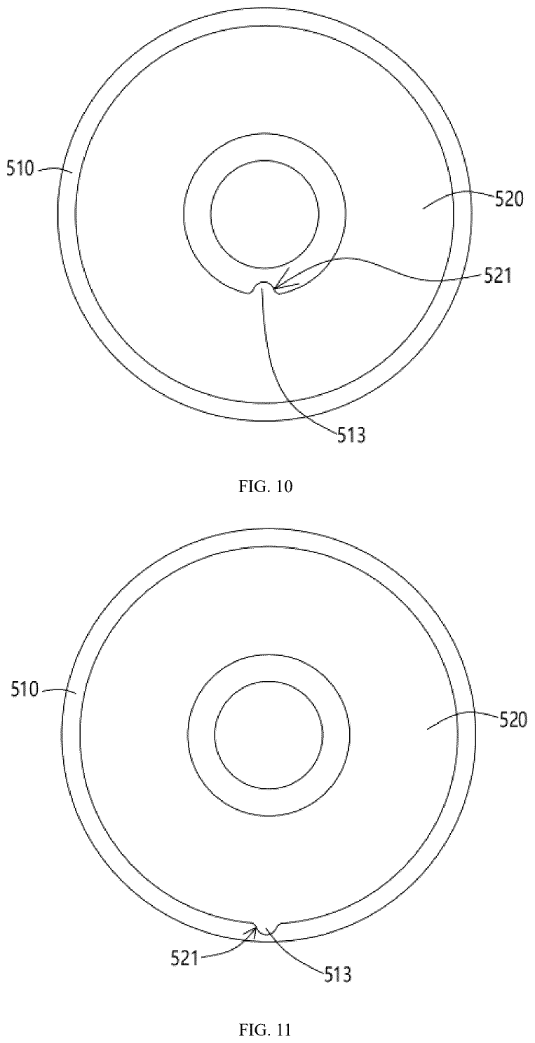

In another optional embodiment, as shown in FIG. 10, an inner circumferential wall of the mounting groove 512 is provided with a limiting groove 521 extending inwards in a radial direction, and a limiting block 513 matched with the limiting groove 521 is formed on an outer circumferential wall of the position feedback part 520.

In another optional embodiment, as shown in FIG. 11, an outer circumferential wall of the mounting groove 512 is provided with a limiting groove 521 extending outwards in a radial direction, and a limiting block 513 matched with the limiting groove 521 is formed on an outer circumferential wall of the position feedback part 520.

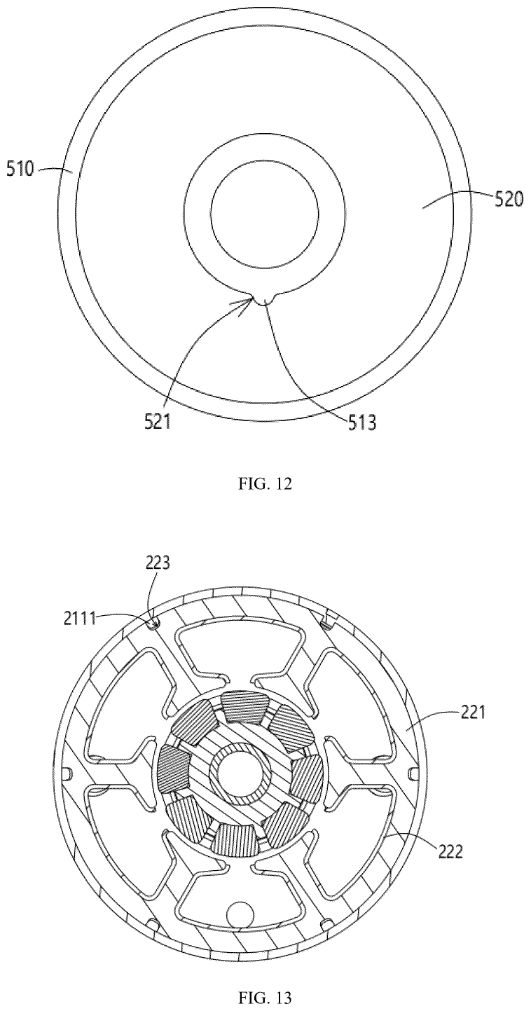

In another optional embodiment, as shown in FIG. 12, an inner circumferential wall of the mounting groove 512 is provided with a limiting block 513 extending outwards in a radial direction, and a limiting groove 521 matched with the limiting block 513 is formed in an outer circumferential wall of the position feedback part 520.

It should be noted that numbers of the limiting blocks 513 and the limiting grooves 521 may be at least one or more, which is not specifically limited in the present application.

As shown in FIG. 13, in an implementable embodiment, an anti-rotation groove 223 is formed in an outer circumferential wall of the stator element 220 of the static assembly 200, the anti-rotation groove 223 extends in a direction parallel to the first axis 110, and the anti-rotation groove 223 penetrates through two opposite ends of the stator element 220 along the first axis 110. An anti-rotation protrusion 2111 matched with the anti-rotation groove 223 is formed on an inner circumferential wall of the shell body 211 of the static assembly 200. When the stator element 220 is positioned and mounted in the shell body 211 through the anti-rotation groove 223 and the anti-rotation protrusion 2111, the anti-rotation groove 223 is fitted with the anti-rotation protrusion 2111 to prevent the stator element 220 from rotating relative to the shell body 211, thereby reducing noise generated by the drive unit.

Meanwhile, the fitting between the anti-rotation groove 223 and the anti-rotation protrusion 2111 can also bear part of stress of a rotation trend of the stator element 220 relative to the shell body 211, so as to reduce the stress on a connection interface between the stator element 220 and the shell body 211, reduce possibility of fatigue damage to the connection interface between the stator element 220 and the shell body 211, and then ensure a relative position of the motion detection assembly 400 and the motion feedback assembly 500 mounted on the stator element 220, so as to improve the precision of the system control.

In practical applications, the surface covering element 222 may only cover an inner wall of a coil slot of the stator bracket 221 and an end surface of the stator bracket 221, and does not involve an outer circumferential wall of the stator bracket 221. Therefore, the anti-rotation groove 223 may be directly formed in the outer circumferential wall of the stator bracket 221, thereby improving connection stability of the stator element 220 and the shell body 211 using a high strength characteristic of the stator support 221. One or more anti-rotation grooves 223 can be provided, and when there are multiple anti-rotation grooves 223, the multiple anti-rotation grooves 223 are arranged at intervals along a circumferential direction of the stator bracket 221, and the number of the anti-rotation protrusions 2111 is less than or equal to the number of the anti-rotation grooves 223.

Referring again to FIG. 2, in an implementable embodiment, bearings are mounted at two ends (for example, the left and right ends in FIG. 2) of the shell element 210 of the static assembly 200 along the extending direction of the first axis 110. The power output shaft 310 of the rotary assembly 300 is rotatably connected with the shell element 210 through the two bearings, the rotor element 320 of the rotary assembly 300 is located in the static assembly 200, the power output shaft 310 is sleeved with a tensioning part 600, the tensioning part 600 has an elastic characteristic, and the tensioning part 600 is located between the rotor element 320 and one of the bearings in a compressed manner. In this way, the elastic characteristic of the tensioning part 600 may provide a necessary preload, so as to maintain tight fit between the bearing and the rotor element 320, reduce axial movement, avoid an influence on a detection effect of the motion detection component, and improve operation precision of the drive unit.

In practical applications, the tensioning part 600 may have an elastic structure, such as a spring or a rubber sleeve, which is not specifically limited in the present application.

Further, the tensioning part 600 and the motion detection component may be located at two opposite ends of the rotor element 320 in the extending direction of the first axis 110, and the distributed layout realizes rationalization and optimal utilization of an internal space of a driving mechanism. Meanwhile, the arrangement of the tensioning part 600 and the motion detection component along the two ends of the first axis 110 helps to reduce potential electromagnetic interference of a tensioning element on detection precision of a motion detection unit.

In an implementable embodiment, the power output shaft 310 may have an axial passage 311, the axial passage 311 extends along the first axis, an axis of the power output shaft 310 or the axial passage 311 is parallel or substantially parallel or coincident with the first axis 110, and the power output shaft 310 is provided with a fluid inlet and a fluid outlet which are communicated with the axial passage 311. Thus, when the drive unit is applied to the oral cleaning device, such as the electric toothbrush, the power output shaft 310 of the drive unit can transmit power to drive the brush head to swing, and can also be used as a flow passage of liquid to convey the liquid to the brush head, such that the irrigation function and the tooth brushing function are achieved at the same time, so as to meet the expectation of the user of combining the irrigator with the toothbrush for use.

In practical applications, the fluid inlet and the fluid outlet are usually located at two ends of the power output shaft 310, and opening directions thereof may be toward a circumferential surface or an end surface of the power output shaft 310.

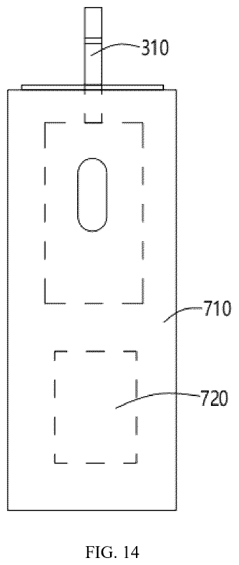

As shown in FIG. 14, the present application further provides a toothbrush handle based on the same inventive concept. Specifically, the toothbrush handle may at least include a grip housing 710, as well as an energy storage component 720 and the above drive unit for oral cleaning mounted within the grip housing 710. The energy storage component 720 is electrically connected with the drive unit, and the power output shaft 310 of the drive unit extends out of the grip housing 710.

In practical applications, the grip housing 710 may have a shape like an elongated body, and a cross-sectional shape of the grip housing 710 may be circular or non-circular (for example, D-shaped, oval, polygonal, or the like) for easy gripping by a user. For a specific structure of the energy storage component 720, reference can be made to an existing battery, and the structure is not repeated herein.

In an implementable embodiment, the toothbrush handle can be applied to an oral cleaning device, such as an electric toothbrush, as a power part and a grip portion. When the toothbrush handle is applied to the oral cleaning device, the power output shaft 310 of the toothbrush handle is detachably connected with a nursing head 750 (such as a toothbrush head and other accessories with bristles), such that the power output shaft 310 drives the nursing head 750 to move.

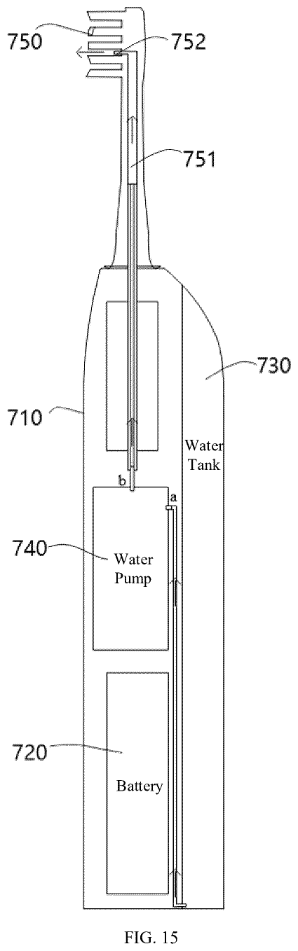

Further, as shown in FIGS. 2 and 15, the toothbrush handle can further integrate functions of swinging and irrigation, and can be applied to an irrigation-brushing all-in-one machine. Specifically, the toothbrush handle further includes a liquid storage chamber 730 and a fluid pumping unit 740 located within the grip housing 710. The power output shaft 310 has an axial passage 311, as well as a fluid inlet and a fluid outlet communicated with the axial passage 311. The fluid inlet of the axial passage 311 may be communicated with the liquid storage chamber 730, and the fluid pumping unit 740 is connected in series in a flow path for communicating the fluid inlet of the axial passage 311 with the liquid storage chamber 730, such that the fluid pumping unit 740 may draw fluid in the liquid storage chamber 730 and allow the fluid to flow out of the fluid outlet of the axial passage 311 through the axial passage 311.

In an implementable embodiment, the toothbrush handle can be applied to an oral cleaning device, such as an irrigation-brushing all-in-one machine, and when the toothbrush handle is applied to the oral cleaning device, a nursing head 750 (such as an irrigation-brushing all-in-one head and other accessories with bristles) of the oral cleaning device has a fluid passage 751 and an outflow opening 752 communicated with the fluid passage 751. The power output shaft 310 is connected with the nursing head 750 and drives the nursing head 750 to perform a displacement motion, the fluid outlet of the axial passage 311 is communicated with the fluid passage 751, and the oral cleaning device outputs water flow through the outflow opening 752 for irrigation.

It should be noted that, for a specific structure of the drive unit, reference may be made to the above description, and the structure is not repeated herein.

The above descriptions are merely preferred embodiments of the application and are not intended to restrict the application. Any modification, equivalent replacement, and improvement made within the spirit and principle of the present application shall be included in the protection scope of the present application.

What is claimed is:

1. A drive unit for oral cleaning, at least comprising a driving body and a motion detection component,
wherein the driving body extending along a first axis (110) comprises a static assembly (200) and a rotary assembly (300), the rotary assembly (300) is rotatably mounted on the static assembly (200), the static assembly (200) at least partially surrounds the rotary assembly (300), an accommodating chamber (120) is formed in the static assembly (200), and at least one end of the rotary assembly (300) extends along the first axis (110) and extends to the outside of the static assembly (200);
the motion detection component at least partially located in the accommodating chamber (120) comprises a motion detection assembly (400) and a motion feedback assembly (500), the motion feedback assembly (500) is connected with the rotary assembly (300) and rotates with the rotary assembly (300), the motion detection assembly (400) is directly connected with the static assembly (200), and the motion detection assembly (400) detects a motion position of the rotary assembly (300) through the motion feedback assembly (500).

2. The drive unit for oral cleaning according to claim 1, wherein the static assembly (200) comprises a shell element (210) and a stator element (220) accommodated within the shell element (210);
the stator element (220) is fixedly connected with the shell element (210), and the motion detection component is located at an end of the stator element (220) along the first axis (110).

3. The drive unit for oral cleaning according to claim 2, wherein the shell element (210) comprises a shell body (211) and a rear cover (212);
the shell body (211) is configured in a cylindrical structure, and an opening (213) is formed in one end of the shell body (211);
the rear cover (212) is connected with the shell body (211) and at least partially covers the opening (213), and the motion detection component is located at an end of the stator element (220) close to the rear cover (212).

4. The drive unit for oral cleaning according to claim 2, wherein the stator element (220) comprises a stator bracket (221) and a surface covering element (222);
the surface covering element (222) at least partially covers the stator bracket (221), and the motion detection assembly (400) is connected with the surface covering element (222).

5. The drive unit for oral cleaning according to claim 4, wherein the surface covering element (222) extends along the first axis (110), and one end of the surface covering element (222) extends to the outside of the stator bracket (221) to form a joining portion (2221), such that the surface covering element (222) is connected with the motion detection assembly (400) through the joining portion (2221).

6. The drive unit for oral cleaning according to claim 5, wherein a support surface (22211) for supporting the motion detection assembly (400) and a positioning connecting piece (22212) extending from the support surface (22211) in a direction away from the stator bracket (221) are formed at an end of the joining portion (2221) away from the stator bracket (221);
a positioning hole (410) matched with the positioning connecting piece (22212) is formed in the motion detection assembly (400), and when the motion detection assembly (400) is positioned and mounted on the joining portion (2221) in an extending direction of the first axis (110) by fitting the positioning connecting piece (22212) with the positioning hole (410), the motion detection assembly (400) abuts against the support surface (22211), a part of the positioning connecting piece (22212) passing through the positioning hole (410) forms, by plastic deformation, a blocking structure extending in a direction perpendicular to the first axis (110) and abutting against a side of the motion detection assembly (400) away from the support surface (22211), so as to block the motion detection assembly (400) from moving in the extending direction of the first axis (110).

7. The drive unit for oral cleaning according to claim 6, wherein a number of the joining portions (2221) is at least two, and the at least two joining portions (2221) are spaced apart around a circumference of the stator bracket (221);
the support surface (22211) for supporting the motion detection assembly (400) is formed at the end of each joining portion (2221) away from the stator bracket (221), and the positioning connecting pieces (22212) extending from the support surfaces (22211) in the direction away from the stator bracket (221) are provided on at least some of the joining portions (2221).

8. The drive unit for oral cleaning according to claim 7, wherein the positioning hole (410) is provided adjacent to an outer circumferential wall of the motion detection assembly (400);
the positioning hole (410) is communicated with the outer circumferential wall of the motion detection assembly (400), and when the positioning connecting piece (22212) is in positioning fit with the positioning hole (410), the positioning connecting piece (22212) is approximately flush with the outer circumferential wall of the motion detection assembly (400), such that projection of the motion detection assembly (400) on the stator element (220) along the first axis (110) is located within a range of the stator element (220).

9. The drive unit for oral cleaning according to claim 8, wherein an inner circumferential wall of the motion detection assembly (400) defines an avoiding space (420);
when the motion detection assembly (400) is connected with the joining portion (2221) of the surface covering element (222), an axis of the avoiding space (420) is collinear with an axis of the rotary assembly (300), such that the rotary assembly (300) can at least partially extend out of the stator element (220) through the avoiding space (420).

10. The drive unit for oral cleaning according to claim 5, wherein an elastic buckle (22213) and a support surface (22211) for supporting the motion detection assembly (400) are formed at the end of the joining portion (2221) away from the stator bracket (221);
a via hole (430) is formed in the motion detection assembly (400), and when the motion detection assembly (400) is connected with the joining portion (2221) along the extending direction of the first axis (110), the motion detection assembly (400) presses the elastic buckle (22213), the elastic buckle (22213) elastically deforms to pass through the via hole (430), and after the elastic buckle (22213) passes through the via hole (430), the elastic buckle (22213) is restored to an initial state to be buckled to a side of the motion detection assembly (400) away from the support surface (22211), and the motion detection assembly (400) abuts against the support surface (22211) to block the motion detection assembly (400) from moving along the extending direction of the first axis (110).

11. The drive unit for oral cleaning according to claim 1, wherein the rotary assembly (300) comprises a power output shaft (310) and a rotor element (320), the power output shaft (310) is rotatably mounted to the static assembly (200), and the rotor element (320) is fixedly connected with the power output shaft (310);
the motion feedback assembly (500) is fixedly connected with the power output shaft (310), the rotor element (320), the motion feedback assembly (500) and the motion detection assembly (400) are arranged at intervals along the extending direction of the first axis (110), the motion feedback assembly (500) is located between the rotor element (320) and the motion detection assembly (400), or the motion feedback assembly (500) is located on a side of the motion detection assembly (400) away from the rotor element (320).

12. The drive unit for oral cleaning according to claim 11, wherein the motion feedback assembly (500) comprises a mounting base (510) and a position feedback part (520);
a connecting hole (511) and a mounting groove (512) are formed in the mounting base (510), the mounting base (510) fixedly sleeves the power output shaft (310) through the connecting hole (511), the mounting groove (512) is formed in a periphery of the connecting hole (511), and a groove opening of the mounting groove (512) is provided towards the motion detection assembly (400);
the position feedback part (520) is mounted in the mounting groove (512) and rotates with the rotary assembly (300).

13. The drive unit for oral cleaning according to claim 12, wherein spacing between the motion detection assembly (400) and the position feedback part (520) ranges from 1 mm to 3 mm.

14. The drive unit for oral cleaning according to claim 12, wherein an outer circumferential wall of the mounting groove (512) is provided with a limiting block (513) extending inwards in a radial direction, and a limiting groove (521) matched with the limiting block (513) is formed in an outer circumferential wall of the position feedback part (520);
or, an inner circumferential wall of the mounting groove (512) is provided with a limiting groove (521) extending inwards in a radial direction, and a limiting block (513) matched with the limiting groove (521) is formed on an outer circumferential wall of the position feedback part (520);
or, an outer circumferential wall of the mounting groove (512) is provided with a limiting groove (521) extending outwards in a radial direction, and a limiting block (513) matched with the limiting groove (521) is formed on an outer circumferential wall of the position feedback part (520);
or, an inner circumferential wall of the mounting groove (512) is provided with a limiting block (513) extending outwards in a radial direction, and a limiting groove (521) matched with the limiting block (513) is formed in an outer circumferential wall of the position feedback part (520).

15. The drive unit for oral cleaning according to claim 1, wherein an anti-rotation groove (223) is formed in an outer circumferential wall of the stator element (220) of the static assembly (200), the anti-rotation groove (223) extends in a direction parallel to the first axis (110), and the anti-rotation groove (223) penetrates through two opposite ends of the stator element (220) along the first axis (110);
an anti-rotation protrusion (2111) matched with the anti-rotation groove (223) is formed on an inner circumferential wall of the shell body (211) of the static assembly (200), and when the stator element (220) is positioned and mounted in the shell body (211) through the anti-rotation groove (223) and the anti-rotation protrusion (2111), the anti-rotation groove (223) is fitted with the anti-rotation protrusion (2111) to prevent the stator element (220) from rotating relative to the shell body (211).

16. The drive unit for oral cleaning according to claim 1, wherein the rotary assembly (300) comprises a power output shaft (310) rotatably mounted to the static assembly (200);
the power output shaft (310) has an axial passage (311), as well as a fluid inlet and a fluid outlet communicated with the axial passage (311).

17. A toothbrush handle, at least comprising a grip housing (710), as well as an energy storage component (720) and the driving apparatus for oral cleaning according to claim 1 mounted within the grip housing (710);
wherein the energy storage component (720) is electrically connected with the driving apparatus, and the power output shaft (310) of the driving apparatus extends out of the grip housing (710).

18. The toothbrush handle according to claim 17, further comprising a liquid storage chamber (730) and a fluid pumping unit (740) located within the grip housing (710);
wherein the power output shaft (310) has an axial passage (311), as well as a fluid inlet and a fluid outlet communicated with the axial passage (311), the fluid inlet of the axial passage (311) can be communicated with the liquid storage chamber (730), and the fluid pumping unit (740) is connected in series in a flow path for communicating the fluid inlet of the axial passage (311) with the liquid storage chamber (730), such that the fluid pumping unit (740) can draw fluid in the liquid storage chamber (730) and allow the fluid to flow out of the fluid outlet of the axial passage (311) through the axial passage (311).

19. An oral cleaning device, at least comprising a nursing head (750) and the brush handle assembly according to claim 17, the nursing head (750) being detachably connected to the power output shaft (310).

20. The oral cleaning device according to claim 19, the brush handle further comprising a liquid storage chamber (730) and a fluid pumping unit (740) located within the grip housing (710);
wherein the power output shaft (310) has an axial passage (311), as well as a fluid inlet and a fluid outlet communicated with the axial passage (311), the fluid inlet of the axial passage (311) can be communicated with the liquid storage chamber (730), and the fluid pumping unit (740) is connected in series in a flow path for communicating the fluid inlet of the axial passage (311) with the liquid storage chamber (730), such that the fluid pumping unit (740) can draw fluid in the liquid storage chamber (730) and allow the fluid to flow out of the fluid outlet of the axial passage (311) through the axial passage (311);
wherein the nursing head (750) has a fluid passage (751) and an outflow opening (752) communicated with the fluid passage (751), the power output shaft (310) is connected with the nursing head (750) and drives the nursing head (750) to perform a displacement motion, the fluid outlet of the axial passage (311) is communicated with the fluid passage (751), and the oral cleaner outputs water flow through the outflow opening (752) for irrigation.
